(19) United States
(12) Patent Application Publication
(10) Pub. No.: US 2025/0259254 A1
(43) Pub. Date: Aug. 14, 2025

(54) REAL ESTATE INVESTMENT ANALYSIS SYSTEM

(71) Applicants: Tamer Assaad, Houson, TX (US); Brendan Thompson, Houston, TX (US); Matt Sanderson, Houston, TX (US)

(72) Inventors: Tamer Assaad, Houson, TX (US); Brendan Thompson, Houston, TX (US); Matt Sanderson, Houston, TX (US)

(21) Appl. No.: 18/442,044

(22) Filed: Feb. 14, 2024

(51) Int. Cl. G06Q 50/16; G06Q 40/06

(52) U.S. Cl. CPC G06Q 50/16; G06Q 40/06

(57) ABSTRACT

A system for real estate investment analysis is disclosed, including at least one user computing device in operable connection with a user network. An application server is in operable communication with the user network to host an application system for providing information related to the real estate investment analysis. The application system includes a user interface module for providing access to the application system through the user computing device. A mapping module is in communication with a display module to illustrate a map having a plurality of properties displayed thereon. An analysis module for analyzing property information to determine a Cap Rate percentage, a Cash on Cash percentage, and an ROI percentage each associated with a property.

### CROSS-REFERENCE TO RELATED APPLICATIONS

The present application claims priority to U.S. Provisional Application No. 63/432,619 filed Dec. 14, 2022, titled “REAL ESTATE INVESTMENT ANALYSIS SYSTEM,” which is hereby incorporated by reference in its entirety.

### TECHNICAL FIELD

The embodiments generally relate to systems and methods for providing investment analysis and more specifically to systems and methods for analyzing the investment return of real estate properties.

### BACKGROUND

Real estate investing involves the purchase, sale, and often the management of real estate in the hopes of realizing a profit on the property. The investment in real estate involves various steps. Often, the valuation of the property is the preliminary step wherein information is used to assess the value of the property. Once the valuation is complete, financing and avenues for investment returns are assessed. To assess potential returns, investors may use a Cap Rate, Cash on Cash or overall return-on-investment (ROI) which account for the listing data, revenue data, and expense data of the property.

In most cases, complex and disparate analysis tools and/or independent research is needed to assess the potential return of the real estate investment opportunity. While this may be effective, these processes can lead to inefficiencies as the investor does not necessarily know the return potential of each property they are viewing.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to a system for real estate investment analysis is disclosed, including at least one user computing device in operable connection with a user network. An application server is in operable communication with the user network to host an application system for providing information related to the real estate investment analysis. The application system includes a user interface module for providing access to the application system through the user computing device. A mapping module is in communication with a display module to illustrate a map having a plurality of properties displayed thereon. An analysis module for analyzing property information to determine a Cap Rate percentage, a Cash on Cash percentage, and an ROI percentage each associated with a property.

The system provides a means for analyzing real estate investment opportunities using a single platform to save time and gain speed to market on each transaction. The system allows user to evaluate multiple markets and properties in various locations across markets and submarkets.

A method for real estate investment analysis is provided. The method includes the steps of receiving and analyzing, via an analysis module, a plurality of listing data, a plurality of revenue data, and a plurality of expense data to determine a Cap Rate percentage, a Cash on Cash percentage, and an ROI percentage for each property. The Cap Rate percentage, Cash on Cash percentage, and ROI percentage are displayed on a property map interface. This allows the user to select between viewing each metric.

In one aspect, an AI engine analyzes the plurality of property listing to assess a plurality of structured data and a plurality of unstructured data to assess if one or more home features can be added to the property.

In one aspect, the AI engine is operable to analyze an active property listing to assess structured and unstructured data.

In one aspect, the AI engine is operable to analyze active rental property listings to determine quality of the rental property listing utilizing one or more descriptions and one or more photos included in the rental property listing.

In one aspect, the AI engine is operable to translate the quality of the rental property listing into an impact on revenue to enhance comparable revenue projections.

In one aspect, a property analysis interface permits a user to view or input at least one of the following: a plurality of property details, one or more revenues, one or more expenses, and financing information.

In one aspect, the analysis module is capable of analyzing a plurality of short term rental properties, a plurality of long term rental properties, and a plurality of medium term rental properties.

In one aspect, a property map interface allows the user to search one or more property listings and select to view a list price, the Cap Rate percentage, the Cash on Cash percentage, and the ROI percentage.

In one aspect, the property map interface permits the user to zoom and to search rental markets, cities, and regions.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 shows a block diagram of a computing system, according to some embodiments;

FIG. 2 shows a block diagram of a computing system and an application program, according to some embodiments;

FIG. 3 illustrates a screenshot of the property map interface, according to some embodiments;

FIG. 4 illustrates a screenshot of the property map interface, according to some embodiments;

FIG. 5 illustrates a screenshot of the property map interface, according to some embodiments;

FIG. 6 illustrates a screenshot of the property map interface, according to some embodiments;

FIG. 7 illustrates a screenshot of the property details interface, according to some embodiments;

FIG. 8 illustrates a screenshot of the property details interface, according to some embodiments;

FIG. 9 illustrates a screenshot of the property analysis interface, according to some embodiments;

FIG. 10 illustrates a screenshot of the property analysis interface, according to some embodiments;

FIG. 11 illustrates a screenshot of the property analysis interface, according to some embodiments;

FIG. 12 illustrates a screenshot of the property analysis interface, according to some embodiments;

FIG. 13 illustrates a screenshot of the property analysis interface, according to some embodiments;

FIG. 14 illustrates a screenshot of the property analysis interface, according to some embodiments; and

FIG. 15 illustrates a flowchart of a process for analyzing real estate information to provide real estate investment metrics, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer-readable program instructions thereon for causing a processor to carry out aspects of the present disclosure.

As used herein, the term “Cap Rate” or “Capitalization Rate” is used to refer to a real estate valuation measure used to compare different real estate investments. In some cases, the Cap Rate may be calculated as the ratio between the annual rental income produced by the real estate asset to its current market value.

As used herein the term “Cash on Cash” or “CoC” is used to refer to a rate of return which calculates the cash income earned on cash invested in a property.

As used herein the term “Return on Investment” or “ROI” is used to refer to a measurement of how much profit one has earned on an investment (the property) as a percentage of the total cost of the investment.

As used herein, the term “Market” is used to refer to a geographic region, e.g., the San Francisco, CA metropolitan area, that includes all buildings or potential buildings available for business occupancy, with boundaries that are consistent with U.S. Census standards and that are generally accepted definitions of metropolitan area.

“Area” is used to refer to an indicator of economic attractiveness of the submarket where the real estate is located; and it is based, for example, upon rents, vacancy, absorption rate and/or other measures of economic attractiveness of a submarket.

“Risk” is used to refer to an indicator of the financial, market and environmental exposure of real estate and of the financial, market and environmental risks associated with the employees and the business entity's occupancy in the real estate.

While the example of short term rentals is often used herein, it is to be understood that the system may be utilized to analyze medium term rentals and long term rentals. These forms of rentals may be used interchangeably herein and examples which state “short term rentals” should not be limited to such. Rather medium term rentals and long term rentals may be applied to any examples described herein.

In general, the embodiments provided herein relate to systems and methods which allow investors to shop for properties for sale by the return it produces on either a Cap Rate, Cash on Cash, or Overall ROI. The app determines these returns (i.e., the Cap Rate, Cash on Cash, or overall ROA) through our in-application analysis which can also be customized by each user. The application pulls in active listing data, revenue data, and expense data and performs an analysis and produces the result in a graphical percent of return. The application also produces a longer more detailed financial analysis. The app also lets you connect with and send the analysis pro forma to on app agents and lenders or other users/investors. The app displays the available for sale homes with the percent return on a map display.

The application program and system is able to access all the data in one place and have the calculations automatically done and shop for homes by their Cap Rate or Cash on Cash or ROI return %. The ROI will encompass debt pay down, appreciation, tax savings (including those from accelerated depreciation from cost segregation studies), payback period, and cash flow. All of these percentages will be displayed on a map showing properties for sale in any given area. There is also a meter that shows how high or low the return is per property and if the investment is poor, good, or great and these categories can be customized by the user.

In some embodiments, the system is operable to gather data. Data gathering may be performed automatically by the system and/or manually by an administrator or collected from third-party data sources. The data may be used to determine revenue or occupancy uplifts for various amenities (i.e., adding a hot tub to a 1 bedroom cabin in Gatlinburg can improve occupancy by 17% and increase an average daily rate by 13%).

In some embodiments, the system may utilize an AI engine to visually scan listing images, Airbnb images to identify additional items like views, proximity, amenities, style of home, quality of home, quality of the home's interior décor, remoteness of the property, and the like. The results of the AI engine's analysis may be coupled with the data analytics to fine-tune and enhance revenue projects.

In some embodiments, the results of the AI engine's analysis may aid the user in contemplating and evaluating the addition of amenities to the property and assess the ROI of such additions. For example, if adding a hot tub costs about $5000 but would increase revenue from $80,000 to $98,000, this change in opportunity will be displayed in total revenue change, as well as in changes to occupancy rate and average daily rate.

In some embodiments, the AI engine may also analyze the active property listing and can access unstructured and structured data to assess if there are additional rooms in the home which can be turned into additional bedrooms. The AI engine may also analyze the active property listing to determine if there is an existing short term rental permit, if the seller is open to creative financing options, and the like.

In some embodiments, the AI engine may be operable to scan vacation and short term rental home listings to determine the quality of that listing using text in the listing, images in the listing and translate the impact on revenue to enhance comparable revenue projections.

In some embodiments, realtors utilizing the system may have the ability to verify certain listings to communicate to users that the revenue projection for a certain property seems accurate in their opinion for the particular market. Realtors may also verify the property from a regulation verification aspect.

In some embodiments, the system and application program may be utilized by users to list properties for sale directly, without the use of third-party property listing platforms.

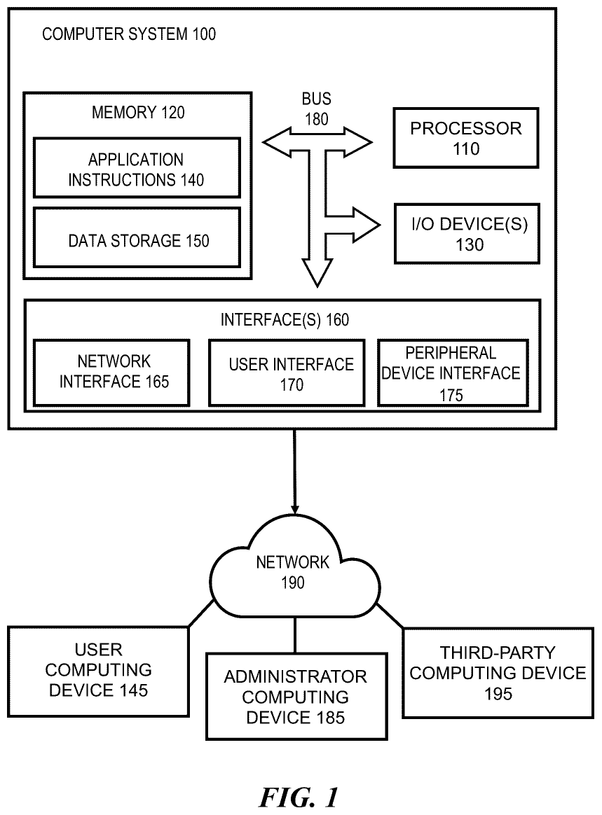

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

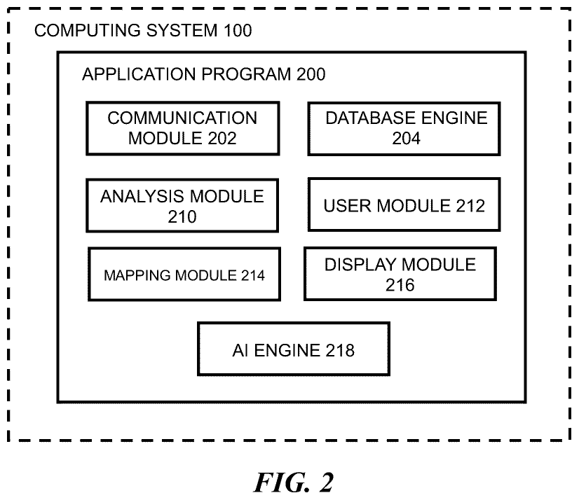

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, an analysis module 210, a user module 212, a mapping module 214, a display module 216, and an AI engine 218.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 210 allow the user to connect with and send the analysis pro forma to on-app agents and lenders or other users/investors utilizing the system. The display module 216 displays the available for sale homes with the percent return on a map display.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the analysis module 210 is in operable communication with the computing device to analyze properties available on a property listing database and/or to analyze properties selected by the user to analyze a property's investment return potential. The analysis module 210 determines these returns (i.e., the Cap Rate, Cash on Cash, or overall ROA) through the in-application analysis module which can also be customized by each user. The analysis module 210 pulls in active listing data, revenue data, and expense data and performs an analysis and produces the result in a graphical percent of return. The application also produces a longer more detailed financial analysis.

In some embodiments, the user module 212 facilitates the creation of a user account for the application system. The user module 212 may allow the user to create a user profile which includes user information, user-associated property information, investment information, location information, investment parameters, user preferences, and the like.

In some embodiments, the mapping module 214 is in operable communication with the computing device to display locations of one or more properties on a mapping interface. The mapping module 214 allows the user to visualize representations of each property on a map while viewing the asking price, Cap Rate, Cash on Cash, ROI, and other metrics associated with each property.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the AI engine 218 may be in operable communication with the analysis module 210 to analyze property information to determine an opportunity for the addition of one or more property features and to determine a new ROI percentage if the opportunity for the addition is added to the property. The AI engine 218 may be operable to analyze an active property listing to assess structured and unstructured data to assess if home features such as additional rooms, amenities (e.g., hot tub, pool, etc.) may affect the ROI (or other metrics) of the home. The AI engine 218 may also analyze active rental property listings to determine quality of the rental property listing utilizing one or more descriptions and one or more photos included in the rental property listing. The AI engine 218 may also translate the quality of the rental property listing into an impact on revenue to enhance comparable revenue projections.

As used herein, the term “home feature” may be used to describe amenities, number of rooms, number of bathroom, and other features which can change the value of the home. For example, the AI engine may analyze if the addition of a home feature, such as a hot tub, will increase the ROI on a property.

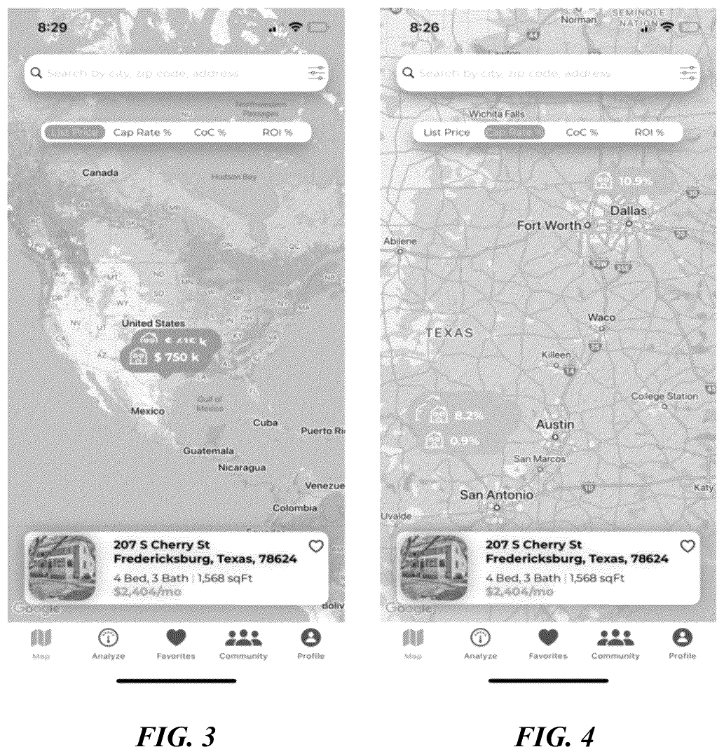

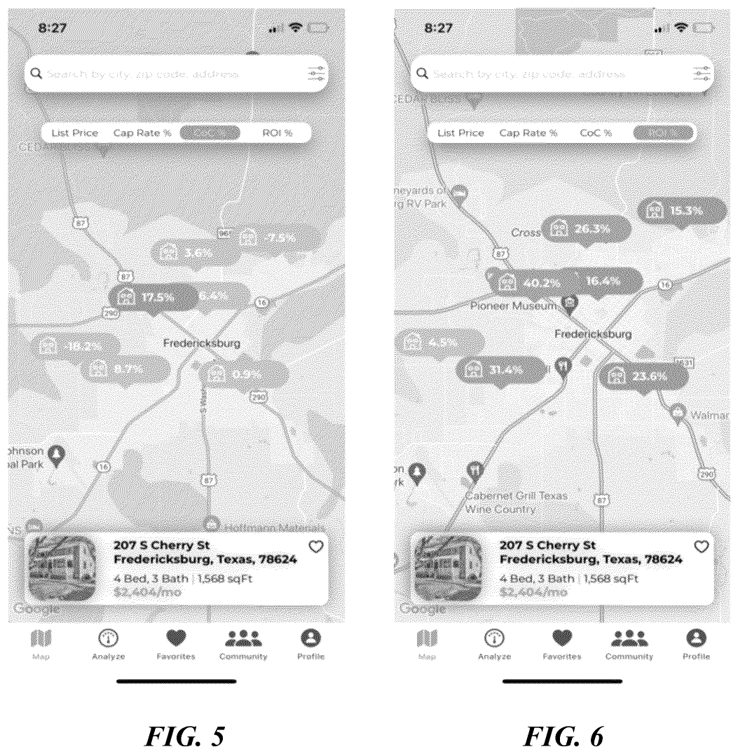

FIGS. 3-6 illustrates a screenshot of the property map interface. The property map interface allows the user to view properties on a map while viewing the property's list price, Cap Rate, Cash on Cash, and ROI percentages. In such, the user may view multiple properties and view their analytics within a single interface. The Cap Rate, Cash on Cash, and ROI percentages are calculated by the analysis module described hereinabove. In particular, FIG. 3 illustrates a map view of the entire country, or other broad region. In FIG. 4 the map has been zoomed and focused into a city or local region which may represent a particular real estate market. The particular real estate market may be defined as an area where homes are comparable (such as by using any home analysis metric) to one another. FIG. 4 also illustrates a view in which the user has toggled to a Cap Rate view, wherein the Cap Rate of the property is shown, rather than the list price (as shown in FIG. 3). FIG. 5 illustrates a similar view of a particular city wherein the user is viewing the Cash on Cash percentage of the property, and FIG. 6 illustrates a view wherein the user is viewing the ROI percentage of the property.

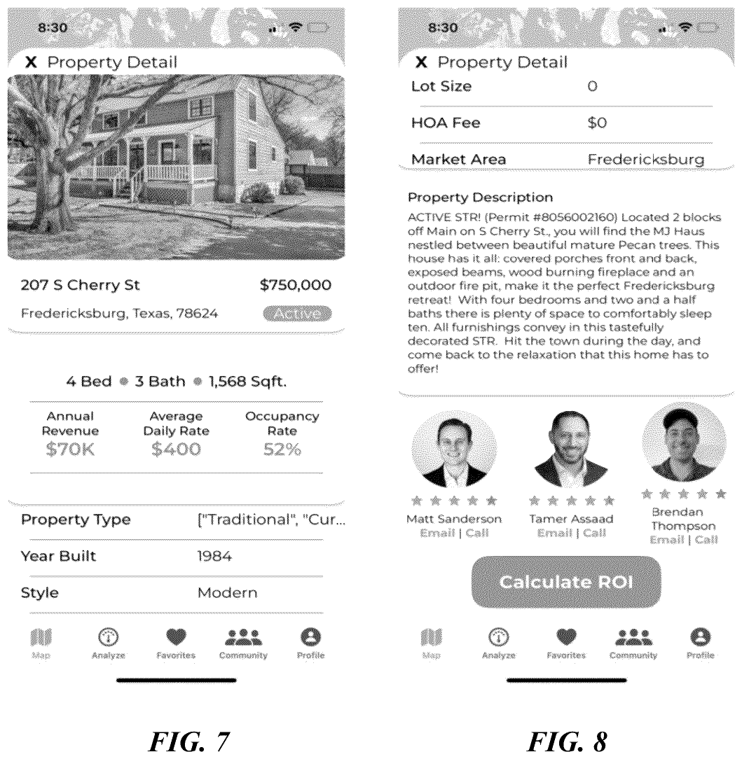

FIGS. 7-8 illustrate the property details interface wherein the user may view listing of the property including descriptions, property analytics, and the like. The property details interface may include property data as the price, price per square foot, cap rate, percent leased, building size, land area, year built, sale status, number of floors, typical floor size, core factor, elevators, building class, land area, lot dimensions, building FAR, zoning, percent leased, available space, vacant space, number of tenants, average tenant size, parking ratio, open parking, covered parking, parking spaces, etc. This section also provides an area for a description of special qualities of the property.

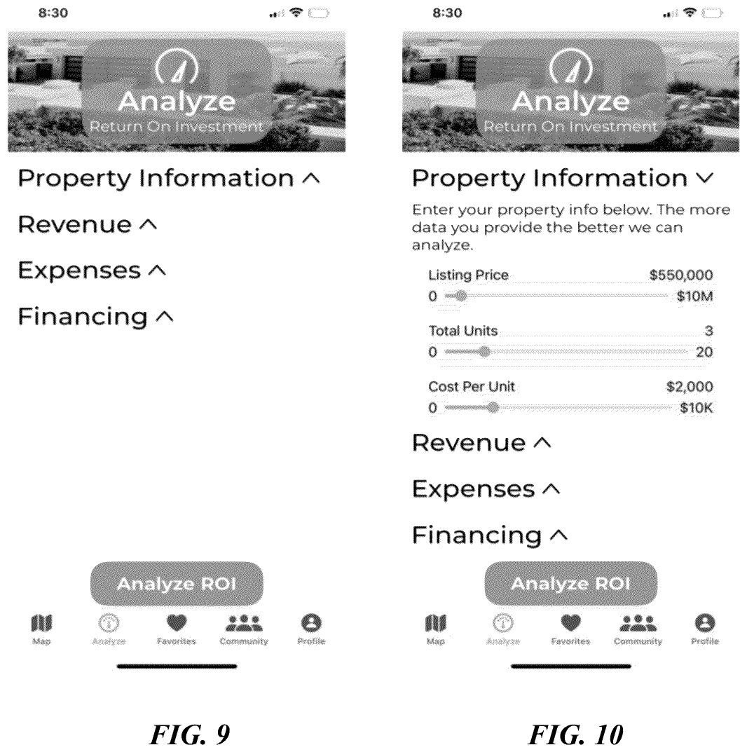

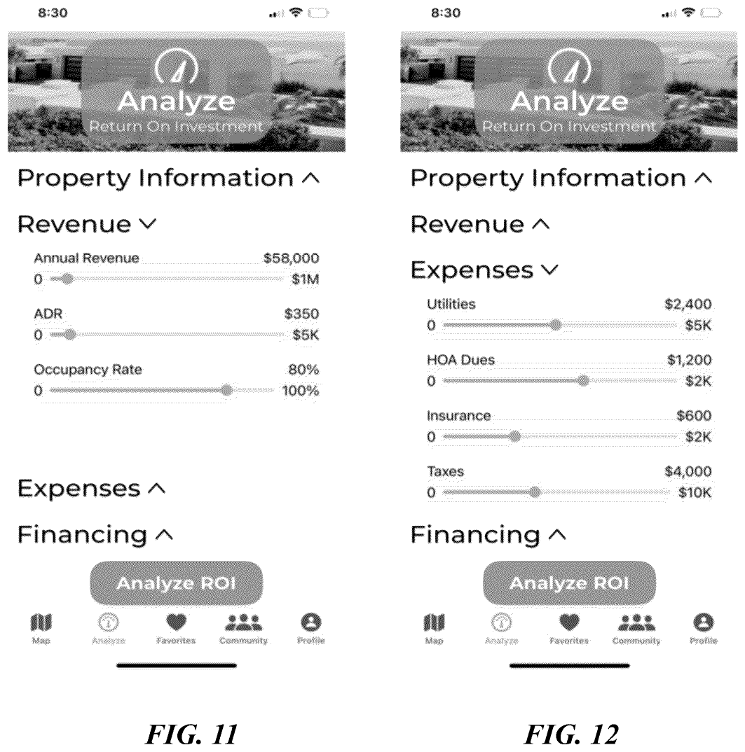

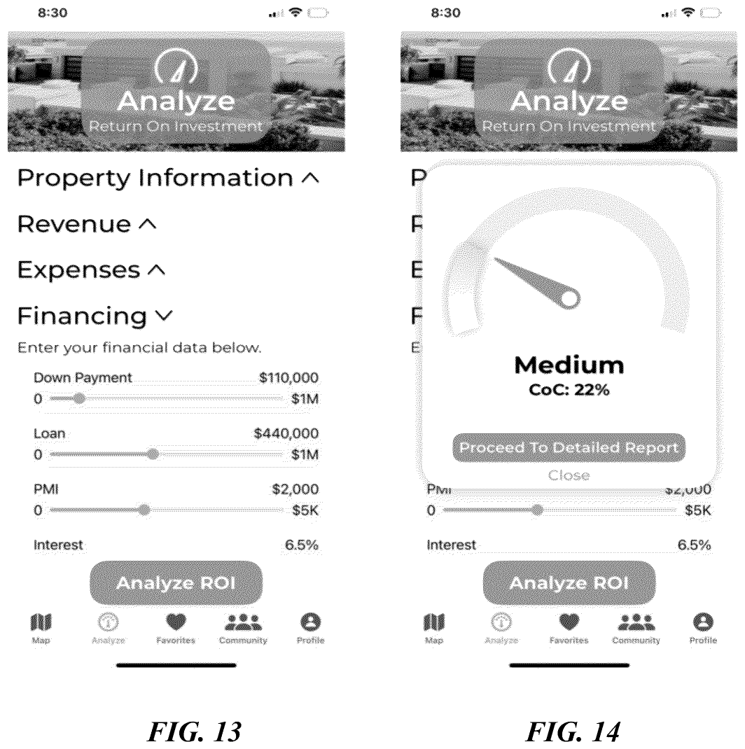

FIGS. 9-14 each illustrate various aspects of the property analysis interface. These interfaces allow the user to view and/or input property information revenue, expenses, and financing information. Users may also view the property list price, projected revenue, including the daily rental rate, occupancy rate (or percentage) for total revenue, and initial project revenue. In some embodiments, the user may also analyze startup costs, recurring costs, and financing details including the down payment, interest rate, etc.

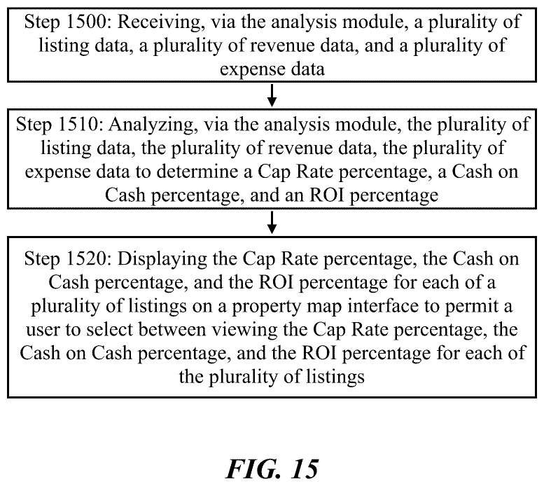

FIG. 15 illustrates a flowchart of a process for analyzing real estate information to provide real estate investment metrics. In step 1500, the analysis module receives a plurality of listing data, a plurality of revenue data, and a plurality of expense data. In step 1510, the analysis module analyzes the plurality of listing data, the plurality of revenue data, the plurality of expense data to determine a Cap Rate percentage, a Cash on Cash percentage, and an ROI percentage. And in step 1520, the Cap Rate percentage, the Cash on Cash percentage, and the ROI percentage for each of a plurality of listings is displayed on a property map interface to permit a user to select between viewing the Cap Rate percentage, the Cash on Cash percentage, and the ROI percentage for each of the plurality of listings.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for real estate investment analysis, the system comprising:
at least one user computing device in operable connection with a user network;
an application server in operable communication with the user network, the application server configured to host an application system for providing information related to the real estate investment analysis, the application system having a user interface module for providing access to the application system through the user computing device;
a mapping module in communication with a display module to illustrate a map having a plurality of properties displayed thereon; and
an analysis module for analyzing property information to determine a Cap Rate percentage, a Cash on Cash percentage, and an ROI percentage each associated with the plurality of properties.

2. The system of claim 1, further comprising a property details interface to display a plurality of property details.

3. The system of claim 1, further comprising a property analysis interface to permit a user to view or input at least one of the following: the plurality of property details, one or more revenues, one or more expenses, and financing information.

4. The system of claim 1, wherein the analysis module is capable of analyzing a plurality of short term rental properties, a plurality of long term rental properties, and a plurality of medium term rental properties.

5. The system of claim 1, wherein the analysis module is operable to determine a change in ROI percentage based on an addition of one or more property features.

6. The system of claim 1, further comprising a property map interface to allow the user to search one or more property listings and select to view a list price, the Cap Rate percentage, the Cash on Cash percentage, and the ROI percentage.

7. The system of claim 6, wherein the property map interface permits the user to zoom and to search rental markets, cities, and regions each containing the plurality of properties.

8. The system of claim 1, wherein the analysis module is customizable by the user.

9. The system of claim 1, wherein the analysis module receives listing data, revenue data and expense data to determine the Cap Rate percentage, the Cash on Cash percentage, and the ROI percentage for the property.

10. A system for real estate investment analysis, the system comprising:
at least one user computing device in operable connection with a user network;
an application server in operable communication with the user network, the application server configured to host an application system for providing information related to the real estate investment analysis, the application system having a user interface module for providing access to the application system through the user computing device;
a mapping module in communication with a display module to illustrate a map having a plurality of properties displayed thereon;
an analysis module for analyzing a plurality of listing data, a plurality of revenue data, and a plurality of expense data to determine a Cap Rate percentage, a Cash on Cash percentage, and an ROI percentage each associated with the plurality of properties; and
an AI engine to analyze property information to determine an opportunity for the addition of one or more property features and to determine a new ROI percentage if the opportunity for the addition is added to the property.

11. The system of claim 10, wherein the AI engine is operable to analyze an active property listing to assess structured and unstructured data.

12. The system of claim 11, wherein the AI engine is operable to analyze active rental property listings to determine quality of the rental property listing utilizing one or more descriptions and one or more photos included in the rental property listing.

13. The system of claim 12, wherein the AI engine is operable to translate the quality of the rental property listing into an impact on revenue to enhance comparable revenue projections.

14. The system of claim 10, further comprising a property details interface to display property details.

15. The system of claim 10, further comprising a property analysis interface to permit a user to view or input at least one of the following: a plurality of property details, one or more revenues, one or more expenses, and financing information.

16. The system of claim 10, wherein the analysis module is capable of analyzing a plurality of short term rental properties, a plurality of long term rental properties, and a plurality of medium term rental properties.

17. The system of claim 10, further comprising a property map interface to allow the user to search one or more property listings and select to view a list price, the Cap Rate percentage, the Cash on Cash percentage, and the ROI percentage.

18. The system of claim 17, wherein the property map interface permits the user to zoom and to search rental markets, cities, and regions.

19. A method for real estate investment analysis, the method comprising the steps of:
receiving, via an analysis module, a plurality of listing data, a plurality of revenue data, and a plurality of expense data;
analyzing, via the analysis module, the plurality of listing data, the plurality of revenue data, the plurality of expense data to determine a Cap Rate percentage, a Cash on Cash percentage, and an ROI percentage; and
displaying the Cap Rate percentage, the Cash on Cash percentage, and the ROI percentage for each of a plurality of listings on a property map interface to permit a user to select between viewing the Cap Rate percentage, the Cash on Cash percentage, and the ROI percentage for each of the plurality of listings.

20. The method of claim 19, further comprising an AI engine capable of performing the following step:
analyzing the plurality of property listing to assess a plurality of structured data and a plurality of unstructured data to assess if one or more home features can be added to the property.
